(19) United States
(12) Patent Application Publication
(10) Pub. No.: US 2004/0208379 A1
(43) Pub. Date: Oct. 21, 2004

(54) Image processing apparatus that adjusts image size to make image divisible into tiles

(76) Inventors: Taku Kodama, Kanagawa (JP); Yasuyuki Nomizu, Kanagawa (JP); Junichi Hara, Kanagawa (JP); Toshio Miyazawa, Kanagawa (JP); Hiroyuki Sakuyama, Tokyo (JP); Yasuyuki Shinkai, Kanagawa (JP); Nekka Matsuura, Kanagawa (JP); Takanori Yano, Kanagawa (JP); Takayuki Nishimura, Tottori (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/762,981

(22) Filed: Jan. 21, 2004

(30) Foreign Application Priority Data
Jan. 22, 2003 (JP) 2003-013571
Jan. 20, 2004 (JP) 2004-012240

(51) Int. Cl. G06K 9/36; H04N 1/41

(52) U.S. Cl. 382/232; 358/426.01

(57) ABSTRACT

An image processing apparatus is disclosed that includes a size adjusting unit and an encoding unit. If the size of a region is fixed, and as a result, an image to be processed by the image processing apparatus is not divisible into the regions, the size adjusting unit adjusts the size of the image so that the image becomes divisible into the regions. The encoding unit encodes the image by the regions and generates a codestream. Accordingly, even if the region is fixed in size, the image can be encoded.

The present application claims priority to the corresponding Japanese Application No. 2003-013571, filed on Jan. 22, 2003, and No. 2004-12240, filed on Jan. 20, 2004, the entire contents of which are hereby incorporated by reference.

### BACKGROUND OF THE INVENTION

1. Field of the Invention

The present invention generally relates to an image processing apparatus, and more particularly, to an image processing apparatus that adjusts the size of an image so that the image can be exactly divided into rectangular regions such as tiles of JPEG 2000.

The present invention further relates to an image forming apparatus in which the image processing apparatus is included, a method of processing an image in which the size of the image is adjusted so that the image can be exactly divided into the rectangular regions, a computer program that causes a computer to function as the image processing apparatus, and a recording medium storing the computer program.

2. Description of the Related Art

Japanese Patent Laid-Open Application No. 2001-197500 discloses a technique in which a portion of an encoded image can be decoded without decoding the entire image, by dividing the image into tiles (rectangular regions) and encoding the image by the tiles.

On the other hand, JPEG 2000 has been internationally standardized as an algorithm for compressing and decompressing an image.

JPEG 2000 can basically handle images of various sizes. However, since JPEG 2000 divides an image into rectangular regions called “tiles” and processes the image by the tiles, if a system can process only tiles of a specific size due to the hardware constraint of the system, the system may not be able to exactly divide the image into tiles. In this case, the image size is not a multiple of the tile size, and peripheral tiles extend beyond the image.

FIG. 9A is a schematic diagram showing an A4 sized image 100 at 600 dpi resolution. The image 100 includes about 7,020×4,920 pixels. In the case where the image 100 is to be divided by tiles of 1,024×1,024 pixels, if the image is covered by 6×4 tiles, a shaded region 101 of the image remains uncovered, as shown in FIG. 9B. If the image is covered by 7×5 tiles, however, the image 100 is fully covered by the 7×5 tiles, but a shaded region 102 adjacent to the image 100 is also covered, as shown in FIG. 9C.

### SUMMARY OF THE INVENTION

An image processing technique that adjusts image size to make image divisible into tiles is described. In one embodiment, an image processing apparatus comprises: a size adjusting unit that, if regions are fixed in size and an image is not divisible into the regions, adjusts the size of the image at a stage in an encoding process to form a size-adjusted image so that the size-adjusted image becomes divisible into the regions; and an encoding unit that encodes the size-adjusted image by the regions into a codestream.

### BRIEF DESCRIPTION OF THE DRAWINGS

FIG. 1 is a schematic diagram showing an image processing apparatus according to one embodiment of the present invention;

FIGS. 2A and 2B are block diagrams showing the basic operations of an encoder unit and a decoder unit, respectively, of the image processing apparatus according to one embodiment;

FIG. 3 is a data diagram showing the structure of a codestream of JPEG 2000 according to one embodiment;

FIG. 4 is a data diagram showing the structure of a main header of the codestream according to one embodiment;

FIG. 5A is a block diagram showing the structure of the encoder unit of the image processing apparatus according to one embodiment;

FIG. 5B is a block diagram showing the structure of the decoder unit according to one embodiment;

FIGS. 6A through 6C are schematic diagrams for illustrating the adjustment of image size by the encoder unit according to one embodiment;

FIG. 7 is a flowchart showing processing by the encoder unit according to one embodiment;

FIG. 8 is a block diagram showing an image processing apparatus according to one embodiment; and

FIGS. 9A through 9C are schematic diagrams for illustrating the dividing of an image by tiles.

### DETAILED DESCRIPTION OF THE PREFERRED EMBODIMENTS

Accordingly, one or more embodiments of the present invention include a novel and useful image processing apparatus in which at least one of the above problems is eliminated.

Another and more specific embodiment of the present invention include an image processing apparatus that can adjust the size of an image.

In at least one of the above embodiments, an image processing apparatus includes: a size adjusting unit that, if regions are fixed in size and an image is not divisible into the regions, adjusts the size of the image at a stage in an encoding process thereby to form a size-adjusted image so that the size-adjusted image becomes divisible by the regions; and an encoding unit that encodes the size-adjusted image by the regions into a codestream.

If the size of a region is fixed, and as a result, the image to be processed is not divisible into the regions, the size adjusting unit adjusts the size of the image so that the image (size-adjusted image) becomes divisible into the regions. The encoding unit encodes the size-adjusted image by the regions, and generates a codestream. Accordingly, even if the region is fixed in size, the image can be encoded by the image processing apparatus.

Other embodiments, features, and advantages of the present invention will become more apparent from the following detailed description when read in conjunction with the accompanying drawings.

The preferred embodiments are described below with reference to the drawings.

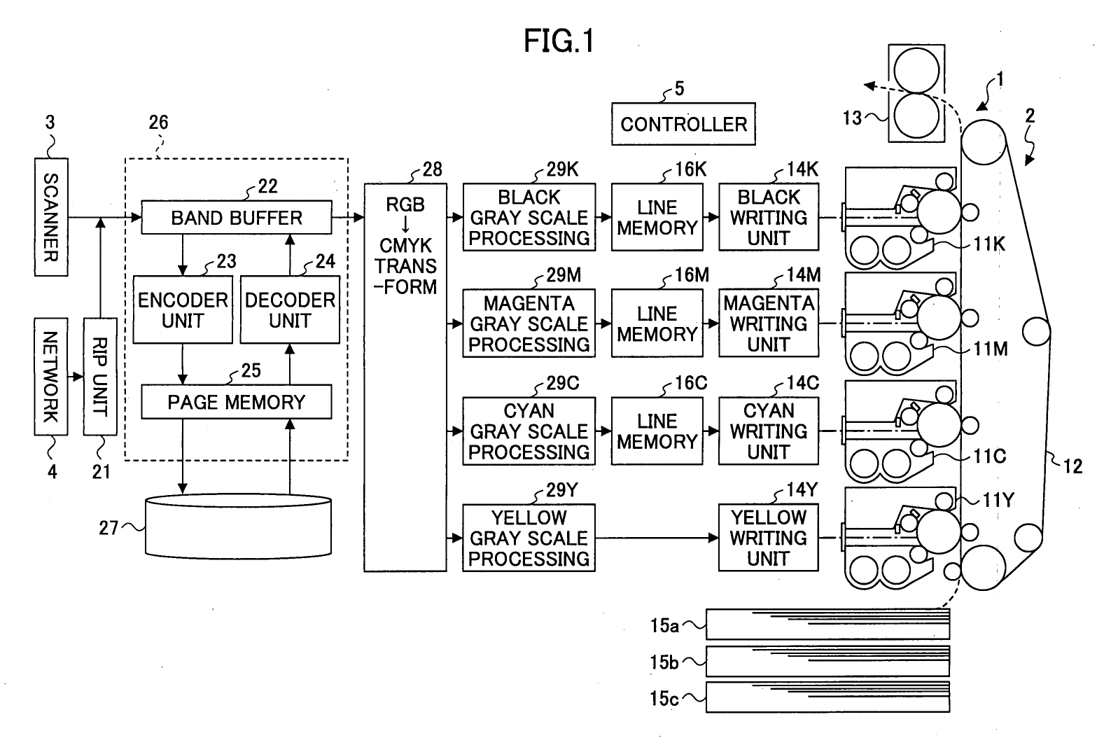

FIG. 1 is a block diagram showing the structure of a digital copier 1 according to one embodiment. The digital copier 1 includes a printer engine 2 for forming an image on paper through an electrophotography process known in the art, for example, and a scanner 3 for reading an image of a document. The digital copier 1 is controlled by controller units (not shown) including a main controller for controlling the entire system of the digital copier 1 and multiple sub-controllers for controlling portions of the digital copier 1 under the control of the main controller.

The printer engine 2 includes a photosensitive unit, a development unit, a cleaning unit, and a charging unit. The printer engine 2 further includes process cartridges 11K, 11M, 11C, and 11Y for forming dry toner images of colors such as black (K), magenta (M), cyan (C), and yellow (Y), respectively. The printer engine 2 further includes a transfer belt 12, a fixing unit 13, and optical writing units 14K, 14M, 14C, and 14Y for writing latent images of respective colors on the photosensitive units provided to the process cartridges 11K, 11M, 11C, and 11Y. The digital copier 1 further includes paper feed trays 15a-15c for storing a recording medium, such as paper and plastic film for an overhead projector, for forming a color image thereon, the recording medium. The process cartridges 11K, 11M, 11C, and 11Y form a color image by superposing toner images of respective colors on the transfer belt 12. The superposed toner images are transferred to the recording medium fed from the paper feed trays 15a-15c, and fixed on the recording medium by the fixing unit 13.

The digital copier 1 includes an image processing apparatus 26 having a controller (not shown), a band buffer 22, an encoder unit 23, a decoder unit 24, and a page memory 25.

The band buffer 22 is a buffer for storing pixel data included in one of multiple bands constituting image data to be printed on a sheet of paper. The band is a region of an image including multiple pixel lines.

The digital copier 1 receives image data from an external resource connected via a network 4 and a communication interface (not shown). When image data received from the external resource via the network 4 are written in the page description language (PDL), a RIP unit 21 converts the image data into bit map data by the bands, and outputs the bit map data to the image processing apparatus 26.

The encoder unit 23 encodes the image data stored in the band buffer 22. The decoder unit 24 decodes code data into which the image data are encoded for compression. According to one embodiment, the encoder unit 23 encodes image data using JPEG 2000, the international standard for encoding still images in order to compress them. The encoder unit 23 hierarchically encodes the image as a whole or encodes each rectangular region (tile) independently by dividing the image into multiple rectangular regions (tiles).

A page memory 25 stores code data into which the image data to be printed on one or more sheets of paper are encoded. It is assumed, however, that the page memory 25 stores the code data of image data for one sheet of paper. The hard disk drive (HDD) 27 receives and stores the code data from the page memory 25 and, when requested, retrieves and transmits the code data to the page memory 25.

A RGB→CMYK transform unit 28 receives image data represented in red (R), green (G), and blue (B) from the band buffer 22 by bands, and transforms the image data into image data represented in cyan (C), magenta (M), yellow (Y), and black (K).

A black gray scale processing unit 29K, a magenta gray scale processing unit 29M, a cyan gray scale processing unit 29C, and a yellow gray scale processing unit 29Y reduce the gray scale of multi-level data of respective colors. For example, 8-bit image data of 600 dpi resolution stored in the band buffer 22 are transformed into 1-bit image data of 1200 dpi by the gray scale processing units 29K, 29M, 29C, and 29Y.

The transformed image data (write data) of black color, magenta color, and cyan color are temporarily stored in line memories 16K, 16M, and 16C, respectively, for the timely forming of images. The respective write data are transferred to a black writing unit 14K, a magenta writing unit 14M, a cyan writing unit 14C, and a yellow writing unit 14Y at timing in which images are superposed.

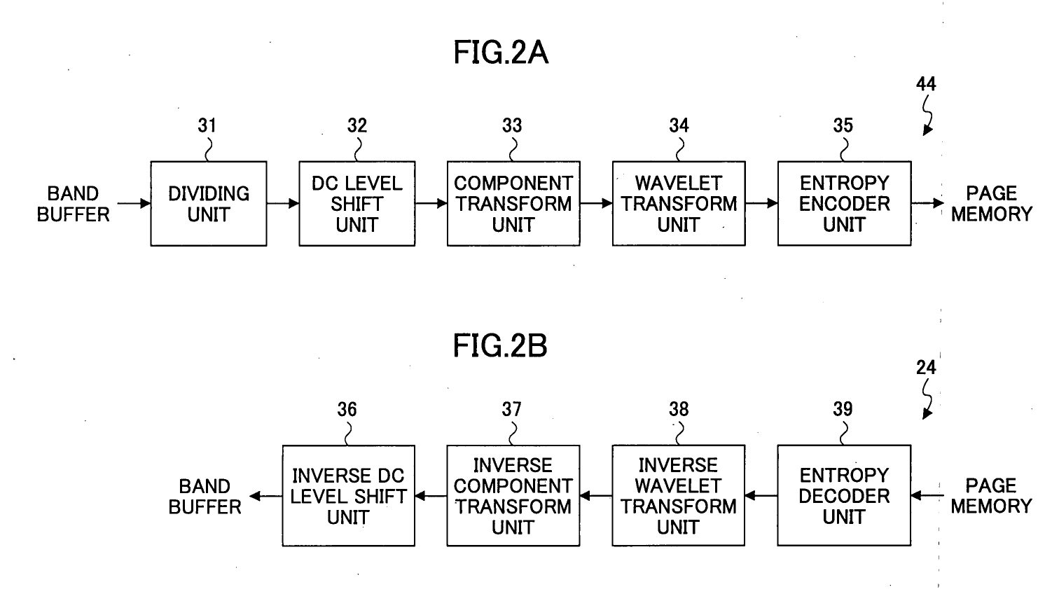

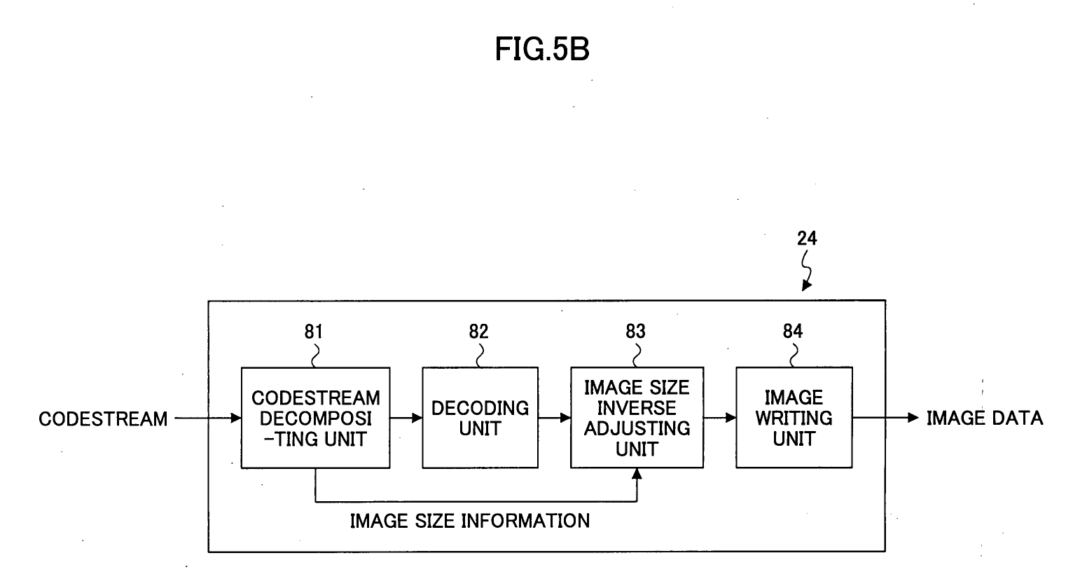

FIG. 2A is a block diagram showing the basic operation of one embodiment of the encoder unit 23 of the digital copier 1. The encoder unit 23 includes a compressing unit 44 (described below with reference to FIG. 5) that encodes and compresses images by performing the basic operation. A dividing unit 31 divides the RGB image data into tiles, if necessary. A DC level shift unit 32 shifts the DC level of the tiles. It is noted that each tile is processed independently from the other tiles, which means the pixel values of each tile are processed without referring to the pixel values of the other tiles. A component transform unit 33 transforms the color space of the image data. A wavelet transform unit 34 transforms the image data with discrete wavelet transform into wavelet coefficients. An entropy encoder unit 35 encodes the wavelet coefficients into entropy codes. The entropy codes are arranged in accordance with a code format before being output to the page memory.

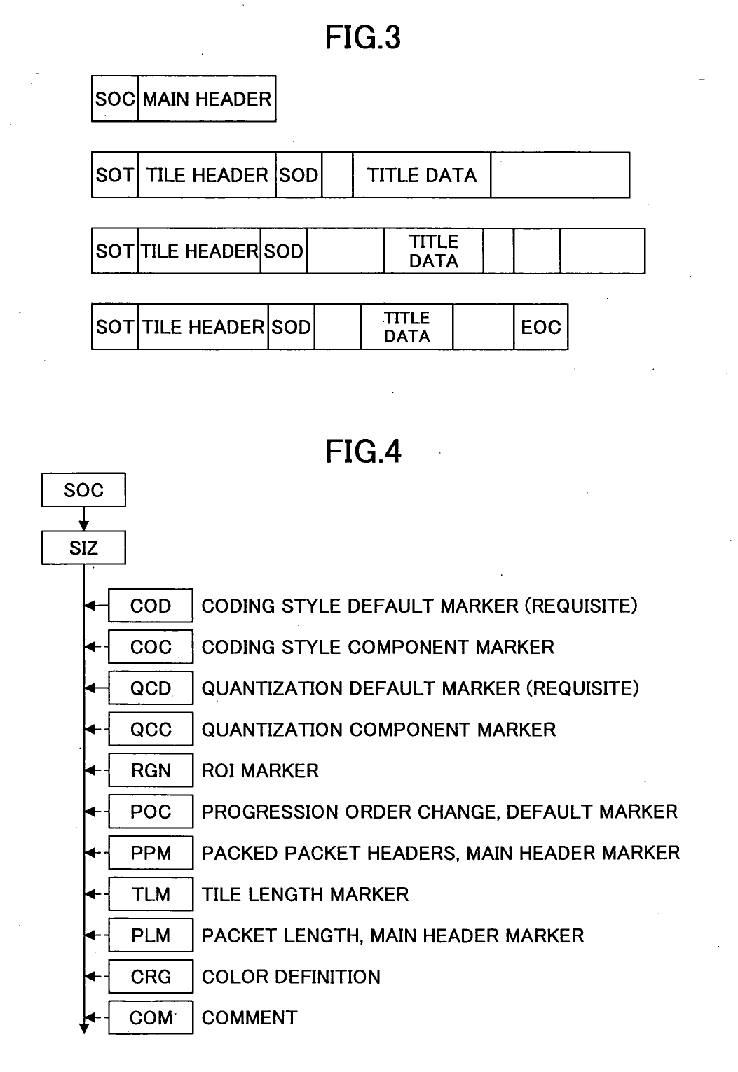

FIG. 3 is a data diagram showing the structure of the code format according to JPEG 2000. A start of codestream (SOC) marker indicates the start of a codestream. A main header follows the SOC marker, the main header containing parameters for encoding and parameters for quantization, for example. Actual code data follow the main header.

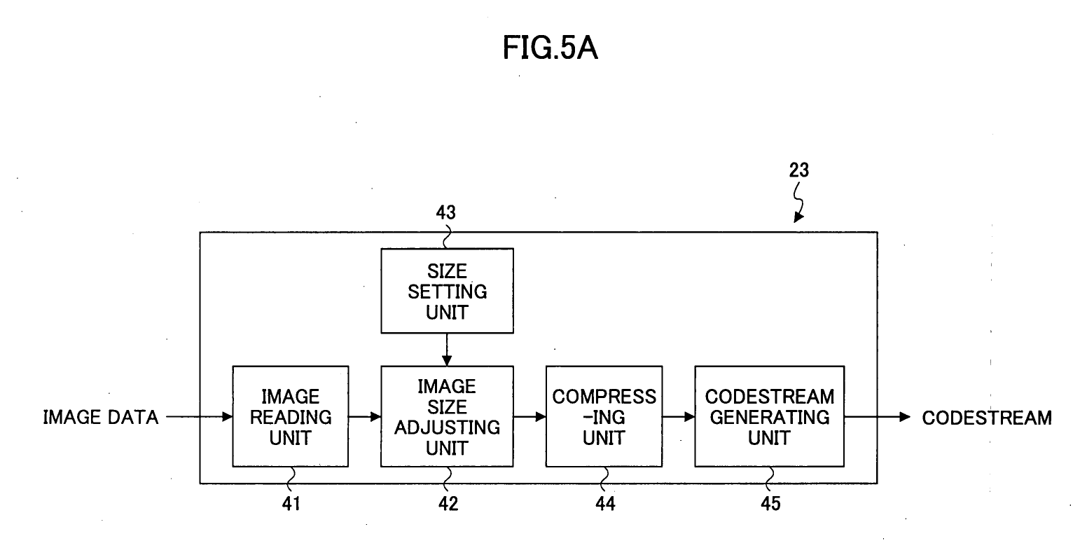

FIG. 4 is a data diagram showing the structure of a main header. The main header includes requisite marker segments COD and QCD, and further includes optional marker segments COC, QCC, RGN, POC, PPM, TLM, PLM, CRG, and COM. The SIZ marker contains information of tile size. The COM marker is usable in both the main header and a tile header, and may contain information such as comments.

The entropy encoding of JPEG 2000 includes a coefficient modeling process and an arithmetic encoding process. Since JPEG 2000 is known in the art as an international standard, a detailed description is omitted.

The decoder unit 24 is described below. FIG. 2B is a block diagram showing the basic operation of the decoder unit 24. The decoder unit 24 performs the inverse transform of the encoder unit 23. The decoder unit 24 includes: an entropy decoder unit 39 that performs the inverse transform of the entropy encoder unit 35, an inverse wavelet transform unit 38 that performs the inverse transform of the wavelet transform unit 34, an inverse component transform unit that performs the inverse transform of the component transform unit 33, and an inverse DC level shift unit that performs the inverse transform of the DC level shift unit 32. If the code data are divided into tiles, the inverse transform is applied to each tile.

FIG. 5A is a block diagram showing the structure of one embodiment of the encoder unit 23. As shown in FIG. 5A, the encoder unit 23 includes an image reading unit 41, an image size adjusting unit 42, a size setting unit 43, the compressing unit 44, and a codestream generating unit 45. The image reading unit 41 reads image data of a band from the band buffer 22. The compressing unit 44 encodes the image data as a whole or encodes each tile independently, into which tiles the image data are divided. The operation of the compressing unit 44 has been described above with reference to FIG. 2A. The code data encoded by the compressing unit 44 are combined into a codestream by the codestream generating unit 45. Information related to the size of the original image is recorded in the COM tag in the codestream.

If the image size of the original image is not divisible by the tile size, the image size adjusting unit 42 adjusts the image size before the compressing unit 44 encodes the image data so that no odd tile remains. The size setting unit 43 determines the size up to which the image size is to be enlarged. The image size may be adjusted by adding pixels of a predetermined pixel value so that the odd tiles that do not cover the image do not remain. The predetermined pixel value may be “0” (indicating a white pixel) or the pixel value of the background of the image. The pixel value of a peripheral portion of the image may be repeated until the image fully occupies the tiles.

FIG. 5B is a block diagram showing the structure of one embodiment of the decoder unit 24. As shown in FIG. 5B, the decoder unit 24 includes a codestream decompositing unit 81, a decoding unit 82, an image size inverse adjusting unit 83, and an image writing unit 84. The codestream decompositing unit 81 acquires a codestream from the page memory 25, and decomposites the codestream into code data. If information related to the original size of the image is stored in the COM tag of the codestream, the information is sent to the image size inverse adjusting unit 83. The decoding unit 82 decodes the code data input from the codestream decompositing unit 81 thereby to restore the image. The decoding unit 82 processes the code data as described above with reference to FIG. 2B. If the size of the data restored by the decoding unit 82 has been adjusted, the image size inverse adjusting unit 83 inverse adjusts the image size based on the information related to the original size of the image sent by the codestream decompositing unit 81 thereby to adjust the image size to the original one. The image of which image size is inverse adjusted is written in the band buffer 22 by the image writing unit 84.

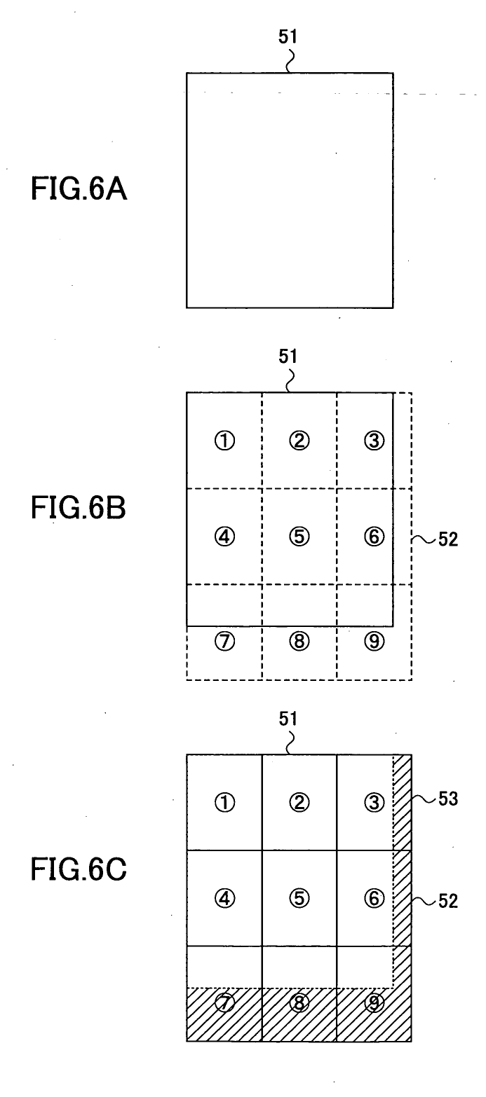

FIGS. 6A through 6C are schematic diagram for illustrating the adjustment of the image size. Image data 51 to be encoded by the encoder unit 23 are shown in FIG. 6A. If the image data 51 are divided into tiles, the image data can be divided by tiles 52 ((1)-(9)) and odd tiles (3), (6), (7)-(9) remain. In this case, pixels (pixel value “0” indicating white pixels, for example) are added to the odd tiles 52 as shown in FIG. 6C as a shaded portion so that the extended image 53 can be divisible by the tiles.

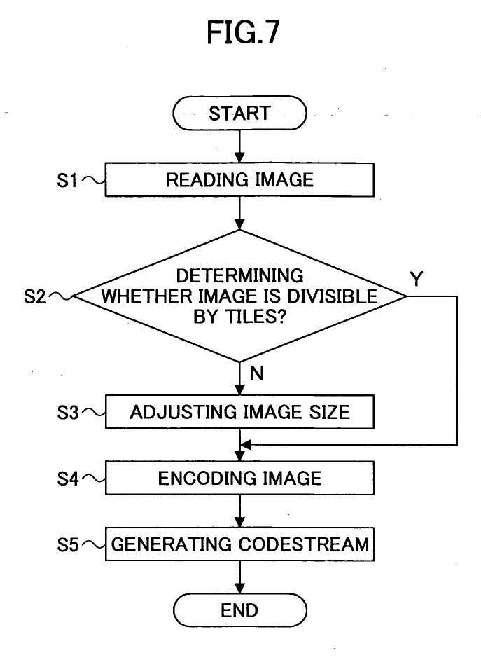

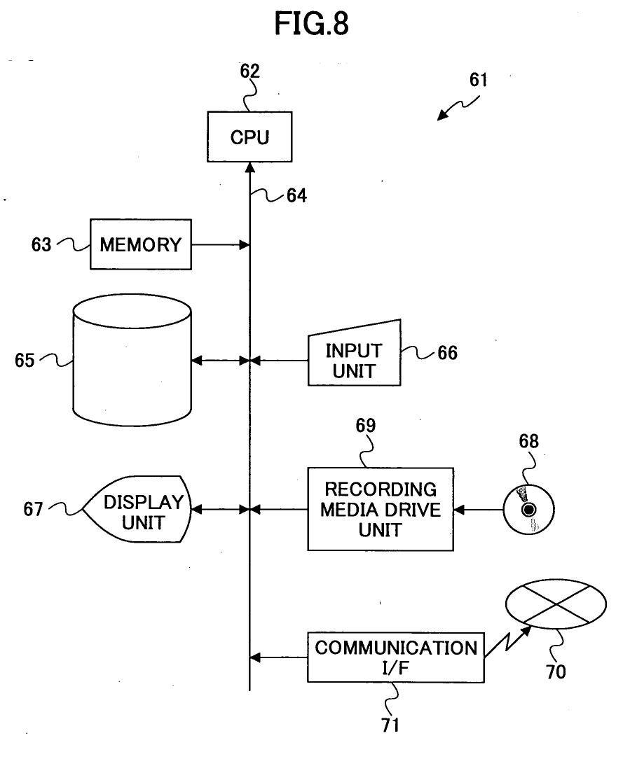

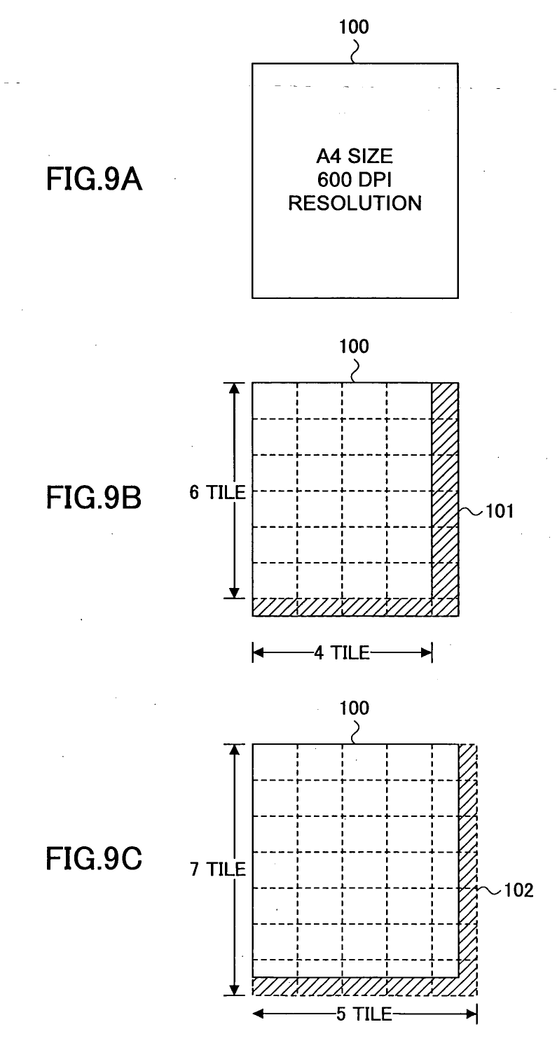

The functional blocks shown in FIG. 8 may be embodied as both hardware and software. FIG. 7 is a flowchart showing the operation of the encoder unit 23. The compressing unit 44 and the codestream generating unit 45 are included in the ASIC built into the digital copier 1, but the other functions are embodied by a controller (not shown) of the digital copier 1.

As shown in FIG. 7, the controller (not shown) causes the image reading unit 41 to read the image of a band (step S1). If the image is not divisible by tiles that the system can process (No in step S2), the image size adjusting unit 42 adjusts the image size thereby to form a size-adjusted image (step S3). The size-adjusted image is encoded by the compressing unit 44 (step S4). The codestream generating unit 45 generates a codestream from code data generated by the encoding of the size-adjusted image (step S5). Information about the original size of the image is stored in the COM tag of the codestream.

In the above description, the image size is adjusted before the compressing unit 44 encodes the image. The image size, however, may be adjusted at any stage in the encoding process by the compressing unit 44.

For example, the size of the image may be adjusted at a stage:

(1) between the component transform and the discrete wavelet transform;

(2) between the discrete wavelet transform and the bit modeling;

(3) between the bit modeling and the arithmetic encoding; or

(4) after the arithmetic encoding.

Processing speed is improved in the order of (1), (2), (3), and (4), but the accuracy of the image is improved in the opposite order.

As described above, since the image size is adjusted before or in the process of the encoding of the image data (step S3), even if the compressing unit 44 can encode the image only by rectangular regions of a predetermined size, the system can process images of various sizes. One embodiment of the present invention is especially effective for images received via the network 4 because the images are often not divisible by the rectangular regions. Even in such a case, the digital copier 1 according to an embodiment of the present invention can handle the images.

Another embodiment of the present invention is described below with reference to the drawings.

FIG. 8 is a block diagram showing the structure of an image processing apparatus 61 according to one embodiment. As shown in FIG. 8, the image processing apparatus is an information processing apparatus such as a PC. The image processing apparatus 61 includes a CPU 62 that centrally controls the entire system of the image processing apparatus 61 and memory 63 including ROM and RAM, for example, connected by a bus 64.

The following devices may be connected to the bus 64 via respective interface: a magnetic storage device 65 such as a hard disk drive, an input device 66 such as a mouse and a keyboard, a display unit 67 such as an LCD and a CRT, a recording media drive unit 69 for writing and reading data to/from a recording medium 68 such as an optical disk, and a communication interface for communicating with an external source via the network 70 such as the Internet. The recording medium 68 may be an optical disk such as a CD and a DVD, a magneto-optical disk, and a flexible disk, for example. The recording media drive unit 69 may be an optical disk drive, a magneto-optical disk drive, and a flexible disk drive, depending on the recording medium 68.

The magnetic storage device 65 stores an image processing program that realizes a computer program according to an embodiment of the present invention. The image processing program may be read from the recording medium 68 by the recording media drive unit 69, and be installed in the magnetic storage device 65. According to another embodiment, the image processing program may be downloaded from the network 70, and is installed in the magnetic storage device 65. The image processing apparatus 61 runs the installed image processing program. The image processing program may be a computer program that runs on an operating system, or a computer program included in an application program.

The image processing apparatus 61 that executes the image processing program thereon operates in the same manner as the image processing apparatus 26 does. The image processing program realizes processing of both the encoder unit 23 and the decoder unit 24. Since the contents of processing of the image processing program are the same as those described with reference to FIGS. 2 through 7, the description of processing of the image processing program is omitted.

The present invention is not limited to these embodiments, but variations may be made without departing from the scope of the present invention.

This patent application is based on Japanese Priority Patent Application No. 2003-013571, filed Jan. 22, 2003, and No. 2004-12240, filed Jan. 20, 3004, the entire contents of which are hereby incorporated by reference.

What is claimed is:

1. An image processing apparatus, comprising:
a size adjusting unit to, if regions are fixed in size and an image is not divisible into the regions, adjust the size of the image at a stage in an encoding process to form a size-adjusted image so that the size-adjusted image becomes divisible into the regions; and
an encoding unit to encode the size-adjusted image by the regions into a codestream.

2. The image processing apparatus as claimed in claim 1, wherein
the encoding unit encodes the size-adjusted image with a JPEG 2000 algorithm.

3. The image processing apparatus as claimed in claim 1, wherein
the size adjusting unit adjusts the size of the image by adding pixels of a predetermined pixel value to the image.

4. The image forming apparatus as claimed in claim 1, further comprising:
an information attaching unit to attach, to the codestream, information related to the size of the image before the adjustment of size.

5. The image processing apparatus as claimed in claim 1, wherein
the size adjusting unit adjusts the size of the image at a stage between a component transform and a discrete wavelet transform.

6. The image processing apparatus as claimed in claim 1, wherein
the size adjusting unit adjusts the size of the image at a stage between a discrete wavelet transform and a bit modeling.

7. The image processing apparatus as claimed in claim 1, wherein
the size adjusting unit adjusts the size of the image at a stage between bit modeling and arithmetic encoding.

8. The image processing apparatus as claimed in claim 1, wherein
the size adjusting unit adjusts the size of the image at a stage after arithmetic encoding.

9. An image forming apparatus, comprising:
the image processing apparatus having
a size adjusting unit to, if regions are fixed in size and an image is not divisible into the regions, adjust the size of the image at a stage in an encoding process to form a size-adjusted image so that the size-adjusted image becomes divisible into the regions; and
an encoding unit to encode the size-adjusted image by the regions into a codestream; and a storage unit that stores the codestream generated by the image processing apparatus;
a decoding unit that decodes the codestream stored in the storage unit; and
a printer engine that forms an image based on the decoded codestream.

10. An image decoding apparatus, comprising:
a decoding unit to decode a codestream into a size-adjusted image; and
an inverse size adjusting unit to re-adjust the size of the size-adjusted image at a stage in a decoding process to form an original image based on information related to the size of the original image attached to the codestream.

11. A method of processing an image, the method comprising:
adjusting, if an image is not divisible by regions of a predetermined size, the size of the image at a stage in an encoding process to form a size-adjusted image so that the size-adjusted image becomes divisible by the regions; and
encoding the size-adjusted image by the regions into a codestream.

12. An article of manufacture having one or more recordable medium storing instructions which, when executed by a computer, cause the computer to perform a method comprising:
adjusting the size of the image, if an image is not divisible by regions of a predetermined size, at a stage in an encoding process to form a size-adjusted image so that the size-adjusted image becomes divisible by the regions; and
encoding the size-adjusted image by the regions into a codestream.

13. The article of manufacture as claimed in claim 12, wherein the computer, when encoding the size-adjusted image, encodes the size-adjusted image with JPEG 2000 algorithm.

14. The article of manufacture as claimed in claim 12, wherein the computer, when adjusting the size of the image, adjusts the size of the image by adding pixels of a predetermined pixel value to the image.

15. The article of manufacture as claimed in claim 12, wherein the method further comprises:
attaching, to the codestream, information related to the size of the image before the adjustment.
